(19) United States
(12) Patent Application Publication
(10) Pub. No.: US 2010/0316972 A1
(43) Pub. Date: Dec. 16, 2010

(54) METHOD FOR THE GENERATIVE PRODUCTION OF INDIVIDUAL DENTAL PREFORMED PARTS FOR ARTICULATORS

(76) Inventors: Martin Klare, Dortmund (DE); Frank Lindner, Dortmund (DE)

Correspondence Address: KF ROSS PC, 5683 RIVERDALE AVENUE, SUITE 203 BOX 900, BRONX, NY, 10471-0900, US

(21) Appl. No.: 12/528,523

(22) PCT Filed: Feb. 9, 2008
(86) PCT No.: PCT/DE08/00248

§ 371 Date: Aug. 25, 2009

(30) Foreign Application Priority Data
Mar. 21, 2007 (DE) 10 2007 014 088.8

(51) Int. Cl. A61C 13/34

(52) U.S. Cl. 433/201.1

(57) ABSTRACT

Method for the production of a denture comprising the following steps:—collection of the biometric data of a patient, namely, the toothed or untoothed mandible and maxilla, the sizing of the jaws, the spatial position thereof relative to the skull, the condyle inclination and the movement of the mandible, and the recording of the mandible movement;—implementation of the data in a virtual articulator which is made available in the main memory of the data processing equipment;—CAD construction of the individual articulator preformed parts and dental molded bodies based on the collected patient data;—production of the individual articulator molded bodies and dental molded bodies by means of a generative manufacturing process based on the recorded biometric data;—incorporation of the individual articulator preformed parts and/or dental molded bodies into a standardized articulator housing, or complete generative manufacture of the articulator with individualized molded bodies.

The invention relates to a method for the generative production of individual dental molded parts for articulators which in comparison to the prior art advantageously image the biometrics of the patient.

### PRIOR ART

Heretofore a working base has been produced as described below. The dentist takes a silicone impression of the dentate or edentate upper jaw and lower jaw. The impressions are cast using plaster. Depending on the application, a bite registration is produced on the fabricated models in order to determine the position of the lower jaw with respect to the upper jaw. The bite registration in combination with the face bow may be used to transfer the spatial position of the jaws to the articulator.

Reference 1 characterizes “the current (2005) commonly used procedure (face bow and mean value articulator) as inadequate, according to scientific criteria, for producing an individual occlusion.” The results are accepted in practice 1. Individual parameters such as the condylar distance are disregarded. The individual parameters are evaluated in reference 4. Five parameters have a major influence on the motion of the jaws. However, these parameters are entered as an average into the simulation, which may be implemented using a mean value articulator. This results in improper occlusion and static problems with the dentures. For example, premature contact may result, causing the dentures to become detached from the jaw. Misalignment of the teeth may cause the dentures to break. In addition, in reference 5 it is reported that even minor dimensional deviations may be crucial for the acceptability of dentures or fillings. If this precision is not met, mispositioning of the jaw, for example, may result, which is an indication of further damage.

Besides mean value articulators there are also full value articulators, for which all parameters are adjusted. These articulators are very costly and are seldom used in practice.

To eliminate the problems described above, other systems have been developed for professional diagnostics. Reference 5 requires that the demands for precision mechanics (accuracies of 10 μm) also apply to dentistry. This may be achieved using various approaches.

One approach is the CompuGnath system by Girrbach, which allows electronic detection of lower-jaw motion in spatial and temporal coordination. In combination with this system, individually machined articulator inserts may be produced for diagnostic and therapeutic motion simulation in the articulator by use of CNC-controlled millers. Here as well, the physical models thus generated must be articulated into a corresponding receptacle. This process is very time-consuming and requires a high level of manual skill. This results in further possible sources of error, such as faulty image reproduction due to a change in volume of the plaster model during the setting phase or improper transfer of the models to the articulator. As a result, the patient situation does not match the model situation. The study by Gartner (2003) describes the function of articulators. In dentistry, articulators represent the static and dynamic occlusion, i.e. the contacts between occlusal surfaces and tooth-guided motion sequences along the occlusal surface. Compared to the actual situation in the oral cavity, there are a number of intangible material- and process-related factors that may adversely affect the motion simulation in the mechanical articulator (for example, the gap-free registrations on plaster models, the spatially correct mounting of the models relative to the skull and joint, the expansion of the assembly and model plasters, the deformation of registration materials, etc.) (2). Other methods are used to perform “articulator programming.” In 2000 Szentpétery 4 introduced software which is able to compute and visualize the motion of an articulator in three dimensions while taking the resulting occlusion into account. On the basis of is typical parameters, for example the condylar inclination, the freedom of motion of an articulator in all six degrees of freedom is mathematically determined and displayed. The individual motion of the lower jaw may be simulated in this manner. Software (such as Condylocomp, Dentron) based on this concept is also available that computes and specifies the above-described possible setting of mean or full value articulators in a virtual articulator. The dentist or dental technician must then adjust these specifications directly on the articulator. These adjustments are very time-consuming and therefore costly. Furthermore, for mean value articulators, individual parameters such as the condylar distance are not taken into account, resulting in less than optimal imaging of the patient biometrics.

As described above, the procedure used heretofore with the mean value articulator and face bow is not satisfactory. In addition, it is not yet possible to implement alternative methods, which require a precise transfer of the oral situation to the articulator, in everyday practice. The primary reason is that the described methods represent additional expenditure of time and labor, and therefore extra cost, for the dentist and dental technician. Furthermore, the sources of error associated with processing the required materials based on silicones and plasters (expansion, etc.) still remain.

Thus, there is a need for a robust method by means of which the biometrics of the patient are imaged as precisely as possible in comparison to the prior art, with the least possible expenditure of time and therefore cost. It is a further aim that the alternative method meet the requirements for an individual working base.

### OBJECT OF THE INVENTION

The object of the present invention is to provide a method for producing dental molded parts, preferably jaw models, as well as functional parts. The aim of this method is to allow economical, precise, functional, and satisfactory production of dentures. A further aim of the invention is to provide a method that qualitatively ensures the transfer of the oral situation to the articulator. In one special embodiment the aim is to allow patient and design data to be archived in a database. This eliminates the need for storing models and functional parts, since these may be easily produced again as needed.

### ATTAINMENT OF THE OBJECT

The present invention provides a method that makes use of existing methods for recording the oral situation. By means of generative fabrication methods, functional parts for the articulator as well as dental molded parts such as lower and upper jaw models are produced. This eliminates the need for all intermediate steps, such as taking impressions of both jaws, model production, position determination for the jaws, and fitting the models into the articulator. Aside from the material properties (expansion characteristics of silicone and plaster), every intermediate step represents a potential source of error.

The method according to the invention is described in the claims.

The invention comprises a method for simulating the oral situation, on the basis of which dental molded parts may be produced.

The concept is based on mechanical articulators, which in addition to the lower and upper jaw models represent the working base for making dentures. The upper and lower jaw models as well as the individual functional parts, for example condyles and joint guidance, are produced by using rapid prototyping (RP) processes. Patient data generated by computerized virtualization of the oral situation and subsequent computation are used as the basis for the above-referenced components. The models and functional parts are introduced into an articulator developed for this purpose.

By use of the invention a working base is provided that reflects the position of the jaws relative to one another and to the skull, the spatial position of the condyles, and the lower jaw motion more accurately than in the prior art. This makes it possible for the dental technician to produce dental molded parts based on individual patient data.

By use of the present invention an individual working base may be produced, since the oral situation of the patient provides individual jaw models and functional parts for the articulator by virtualization and computation of the patient information.

The goal is for the dentist to digitally record and process the individual patient data and create a file that an RP process is able to read for the required construction process. The individual models and individual functional parts for a particular articulator are fabricated using the RP process. The dentist sends either the data or the models and functional parts to the dental laboratory where the dental technician incorporates the models and functional parts into the articulator. On the basis of this working base, the dental technician is able to produce a dental work unit that is individually adjusted to the patient with regard to occlusion and function. Taking a silicone impression, producing the jaw model from plaster, preparing the bite registration, fitting the models into the articulator, and transferring the patient data into the articulator is made unnecessary by this procedure. Furthermore, it is advantageous that the entire process is qualitatively documented and verified.

The invention may be divided into two parts. In the first part the jaw models, which are provided with a receptacle for the articulator, are produced by the RP process.

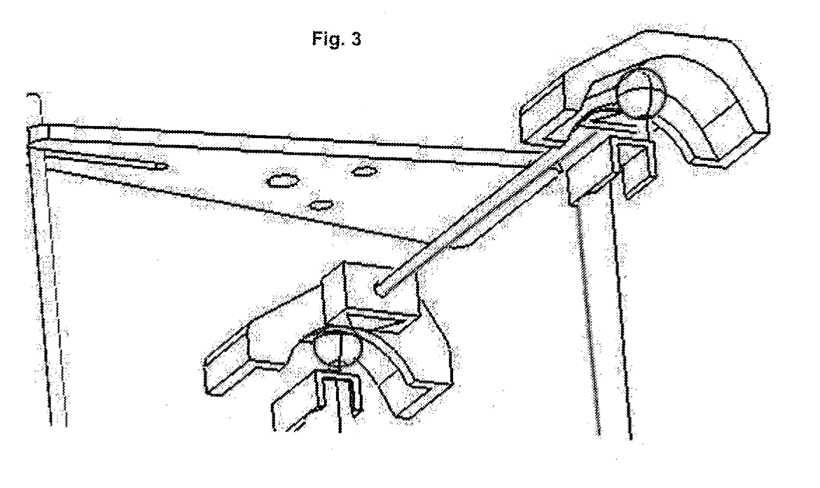

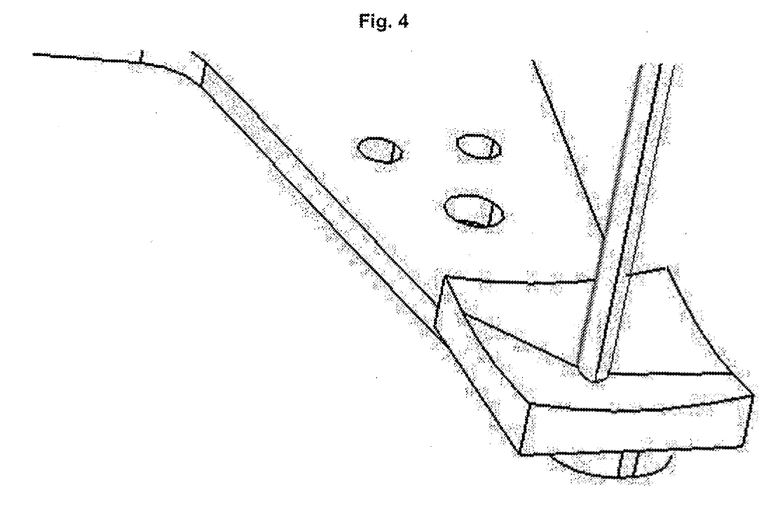

The second part of the invention involves the generative production of the functional parts, which are provided with a receptacle for the articulator in order to image the biometrics of the patient. The functional parts specify the individual motion of the lower jaw, which in comparison to the prior art is not an average-value motion. The functional parts include the condylar and incisal guides (FIGS. 3 and 4) and the condyles. The dimensioning, spatial position, and alignment of the functional parts are accordingly based on the oral situation of the patient in an individualized manner. Thus, the present invention is able to implement all adjustment settings of a fully adjustable articulator (a Stuart articulator, for example) with a much lower expenditure of time.

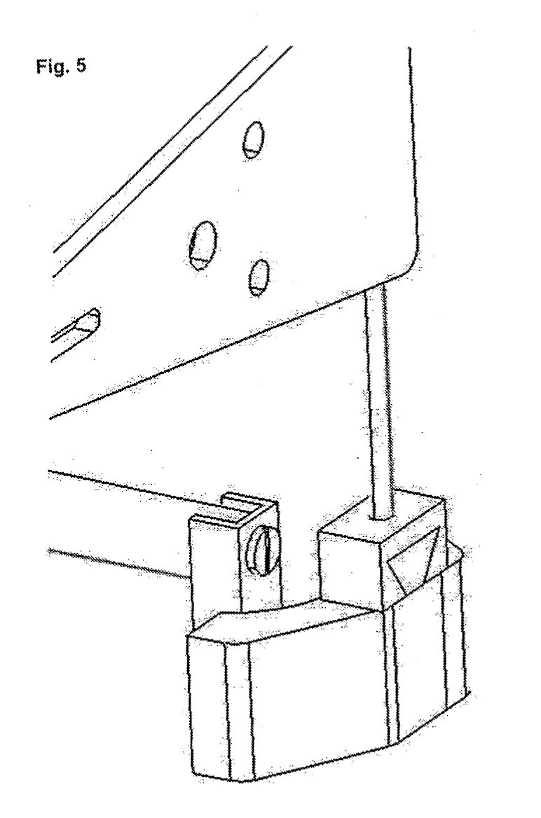

The models and functional parts are mounted on an articulator provided for this purpose. The connecting elements used may have a positive fit or a form fit. A screw and pin connection is illustrated in FIG. 5.

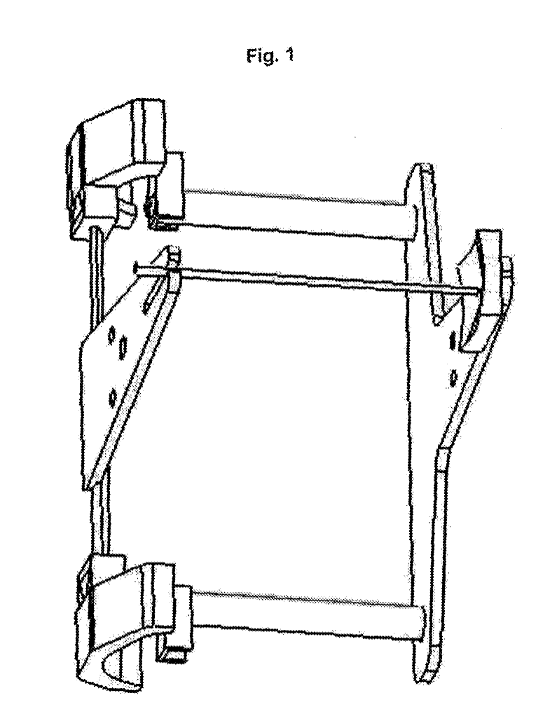

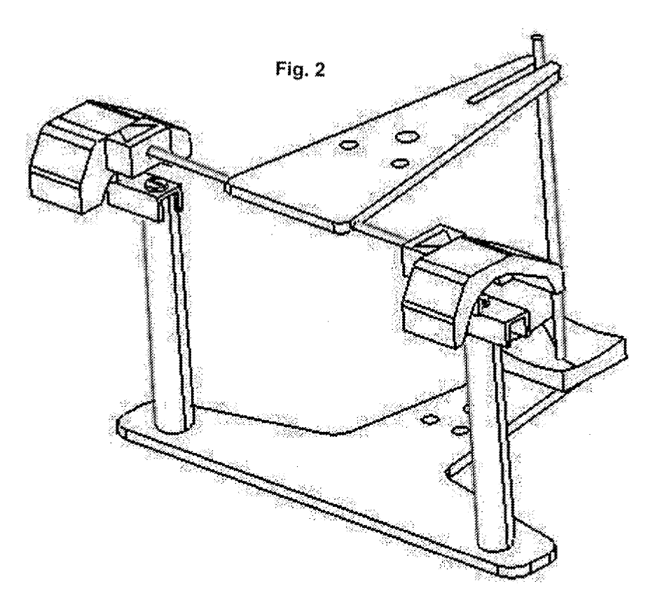

An articulator is shown in FIG. 1. Details of the articulator are shown in FIGS. 2 through 5.

The method comprises the following steps:

Collection of the patient data by 3-D X-ray, for example, digitizing the data, and digitally recording the lower jaw motion, and storing the data in a memory of an electronic data processor for computerized processing;

Entry of the prepared patient data into a virtual articulator that is stored in the memory of the data processor, generation of the individual articulator molded parts, construction of the dental molded bodies taking the collected patient data into account, and production of the molded bodies by use of a generative fabrication process. Processes such as stereolithography, 3D printing, direct light processing (DLP), laser sintering, and LaserCusing (FIGS. 1 and 2) may be used for this purpose;

Incorporation of the molded bodies into a standardized articulator housing (FIGS. 1 and 2).

Various elements such as screws, magnets, attachments, etc. may be used as connectors (FIG. 5).

As a further possibility, the generative production of the articulator using individualized molded bodies is claimed. For the application, an articulator or apparatus as schematically illustrated in FIGS. 1 and 2 is used.

Carrying out the method requires appropriate software, namely:
Software for processing the patient data in order to construct the components;
Software for controlling the RP machine;
Software for documenting the production process;
Software for archiving the patient and component data; and
Software for combining the above-referenced functions.

The drawing figures show the following:

FIG. 1 shows a front view of an articulator;

FIG. 2 shows the articulator from another viewing direction;

FIG. 3 shows a detailed view with condyles and condyle guidance;

FIG. 4 shows a detailed view with incisal pin guidance; and

FIG. 5 shows a detailed view of a connecting region.

### REFERENCES

1. www.zahnwissen.de
   2. Gärtner, The DentCAM virtual articulator, Dissertation, University of Greifswald, 2003
   3. www.picodent.de
   4. Szentpétery, Three-dimensional mathematical motion simulation of articulators and their use in the development of a is software articulator, Dissertation, University of Halle-Wittenberg, Halle (Saale), 1999
   5. www.nifix.com

1. A method for making dentures by
collection of the biometric data of a patient, namely, the dentate or edentate upper jaw and lower jaw, the dimensioning of the jaws, the spatial position thereof relative to the skull, the condylar inclination and the movement of the lower jaw, and recording of the lower jaw movement;
entry of the data into a virtual articulator that is stored in the memory of a data processor;
CAD design of the individual articulator molded parts and dental molded bodies based on the collected patient data;
production of individual articulator molded parts and dental molded bodies using a generative fabrication process based on the recorded biometric data;
incorporation of the individual articulator molded parts and/or dental molded bodies into a standardized articulator housing, or complete generative fabrication of the articulator using individualized molded bodies.

2. The method according to claim 1 wherein
a stereolithographic process,
a 3D printing process,
a direct light processing process,
a laser sintering process, or
a lasercusing process
is used as the generative fabrication method.

3. The method according to claim 1 wherein the biometric data are recorded using a 3-D X-ray.

4. The method according to one claim 1 wherein the recorded data are digitized and stored in a memory of the data processor.
